(19) United States
(12) Patent Application Publication
(10) Pub. No.: US 2010/0037874 A1
(43) Pub. Date: Feb. 18, 2010

(54) TWO-STROKE ENGINE EMISSION CONTROL

(75) Inventor: Imack Laydera-Collins, Benton, LA (US)

Correspondence Address: ADAMS INTELLECTUAL PROPERTY LAW, Suite 2350 Charlotte Plaza, 201 South College Street, CHARLOTTE, NC, 28244, US

(73) Assignee: YAT Electrical Appliance Company, LTD, Zhejiang (CN)

(21) Appl. No.: 12/539,992

(22) Filed: Aug. 12, 2009

Related U.S. Application Data
(60) Provisional application No. 61/088,024, filed on Aug. 12, 2008.

(51) Int. Cl. F02F 1/22; F02B 75/06

(52) U.S. Cl. 123/65 P; 123/192.2

(57) ABSTRACT

A two-stroke internal combustion engine is provided. The engine includes a block defining a crankcase for enclosing a fuel mixture and a cylinder chamber formed at an end of a cylinder bore, an air passage in fluid communication with the cylinder bore, a scavenging transfer passage communicating between the crankcase and the cylinder chamber and having a primary transfer port in communication with a secondary transfer port, the secondary port having a first and a spaced-apart second window with a bridge spanning the space therebetween, and a piston slideably positioned in the cylinder bore and having a channel formed in a periphery of the piston and having a piston opening defined therein for providing selective communication between the crankcase and the transfer passage.

### CROSS-REFERENCE TO RELATED APPLICATIONS

This application claims priority to U.S. Provisional Patent Application No. 61/088,024 which was filed on Aug. 12, 2008, the contents of which are hereby incorporated.

### BACKGROUND OF THE INVENTION

The typical design of two-cycle engines uses a stream of new air/fuel mixture to finish evacuating the burned gases left in the cylinder chamber from the previous combustion cycle. The exhaust port remains open during the time while the scavenging ports that are in communication with the crankcase are open. This causes some of the scavenging gases (air-fuel mixture) to escape through the exhaust port. These un-burned gases then escape to the atmosphere creating pollution and reducing fuel efficiency.

Many improvements have been made throughout time to improve the filling of the cylinder chamber with fresh mixture and to avoid losses of fuel. Some of these improvements include special geometry of the transfer passages configured to direct the scavenging gases into the cylinder chamber with the objective of filling the combustion chamber with raw mixture, displacing burnt gases while minimizing raw mixture loss. The pattern on how to better direct the scavenging gases into the cylinder chamber is called Schnuerle's effect.

Another system invented to minimize the loss of raw mixture is called the “air head”. Such a system includes the pre-introduction of a small amount of air into the cylinder chamber before the introduction of the air/fuel mixture. The theory behind that is to provide a volume of air into the scavenging gases to evacuate the burned gases. The volume of air is followed by the air/fuel mixture. This method is also called stratified scavenging. Stratified scavenging has its roots in the late 1800's and is mentioned in the works of Sir Douglas Clerk, inventor of the two-cycle engine, who created the concept of “air head” with the sole purpose of increasing engine fuel efficiency. It was just after the late 1980's that, due to pressure of regulatory agencies, manufacturers started seeking ways to minimize emissions. Stratified scavenging then emerged as one of the preferred systems to achieve these goals.

The basic principles of stratified scavenging are known. Most recent developments related to stratified scavenging have been directed to providing the right timing for air injection, controlling the engine performance and emissions, providing the right amount of air, modifying the routes through which the air could be introduced into the cylinder chamber, and controlling the timing of the air introduction and ejection. The timing of air introduction and ejection has been controlled by the use of reed valves or piston ported passages.

Research indicates that using multiple scavenging ports will provide better stratification rather than using a single pair of ports. Also, it is desirous to introduce the air volume first in the ports closer to the exhaust port (primary ports). This will create a sort of barrier of air between the air/fuel mixture ejected from the secondary ports farther away from the exhaust ports.

### BRIEF SUMMARY OF THE INVENTION

The object of the present invention is to provide a stratified scavenging engine that introduces a predetermined efficient amount of airhead in the desired direction and with the proper timing.

According to one embodiment of the present invention, there is provided an engine that utilizes a port configuration for first creating the air barrier near the exhaust port and to direct the fuel mixture into the cylinder chamber using Schnuerle's principle (loop scavenging). The port configuration allows creating the barrier in front of the exhaust port and at the same time, concurrently directing the gases around the cylinder to evacuate the burnt combustion gases.

The port configuration of the present invention provides for timely discharging a volume of air from both the primary and secondary scavenging ports and then followed by discharging the volume of air/mixture from the ports. During the operation of one embodiment of the present invention, the transfer passage closer to the exhaust port is pre-pressurized since it is always in fluid communication with the crankcase, while the secondary transfer system is fluidly connected to the crankcase only when the piston is in a first position (bottom dead center position) and is not fluidly connected to the crankcase i.e., blind, when the piston is in a second position (top dead center position). Both ports discharge the air head into the cylinder chamber, and because the primary port is pre-pressurized, it does it first, then the secondary port discharges. In both ports the air-fuel mixture follows the air.

When the pre-pressurized transfer passage window (port) is opened by the edge of top of the piston, there is an immediate release of the fluids contained into the transfer passage, while in the secondary transfer passage, the gases from the crankcase need to fill the blind space, and then move towards the opened port. This differential on timing will allow the air contained in the primary transfer port to be circulated into the cylinder chamber first then the secondary port, prior to the ejection of the fuel/air mixture. In one embodiment of the present invention, the differential on timing is approximately 0.0002″ of a second at normal engine speeds. Typically delaying transfer port ejection is done by raising or lowering the top edge of the ports in relation to each-other. The delay on the air or fuel/air ejection from the transfer ports can be affected negatively by what is called blow-down gases. This phenomenon occurs when there is a higher pressure inside the cylinder chamber than in the crankcase. This causes the combustion gases to travel down the first port to open. This affects negatively the effect of port height and discharge timing is difficult to predict.

It also must be noted that several manufacturers have tried to reach the ports adjacent to the exhaust port with external ducting from the air filter, or long channels through the piston skirt. These methods increase the width of the engine or increase the weight of the piston since the lower peripheral channels creates undercuts in the internal walls difficult to core out by traditional die cast systems. The design of the engine of the present invention is configured such that the air is transferred towards the primary scavenging passages adjacent to the exhaust port without using external ducting. Also the features are designed to allow easy manufacturing by die-casting.

The engine of the present invention is configured to connect the crankcase to the combustion chamber by using a blind port and a long vertical conduit outside the cylinder bore. Once the air has reached the blind port, air is circulated into the primary port through an opening at the top of the transfer passage side cover. The air circulated into the primary port is drawn by the negative pressure existing within the crankcase. Alternatively, a channel into the piston skirt can be used for the same purposes.

One object of the present invention is to provide the appropriate timing for releasing the air head into the cylinder chamber, thus improving the engine efficiency while maintaining to a minimum the raw hydrocarbon losses.

Another object of the present invention is to provide a stratified scavenging engine that utilizing relatively fewer components.

Another object the present invention is to provide a two-cycle engine configured to provide adequate delivery of pure air into the cylinder chamber while maximizing the delivery of air/fuel mixture to increase the engine specific power and further reduce raw hydrocarbon losses.

### BRIEF DESCRIPTION OF THE DRAWINGS

The subject matter that is regarded as the invention may be best understood by reference to the following description taken in conjunction with the accompanying drawing figures in which:

FIG. 1 is a front view of a two-cycle engine according to one embodiment of the present invention;

FIG. 2 is a left side view of the engine of FIG. 1;

FIG. 3 is a cross-sectional view of the engine of FIG. 1 taken along line DD;

FIG. 4 is a cross-sectional view of the engine of FIG. 2 taken along line EE;

FIG. 5 is a cross-sectional view of the engine of FIG. 1 taken along line HH;

FIG. 6 is a cross-sectional view of the engine of FIG. 2 taken along line GG;

FIG. 7 is a front view of a cylinder of the engine of FIG. 1;

FIG. 8 is a cross-sectional view of the cylinder of FIG. 7 taken along line AA;

FIG. 9 is a left-side view of the cylinder of FIG. 7;

FIG. 10 is a cross-sectional view of the cylinder of FIG. 9 taken along line DD;

FIG. 11 is a cross-sectional view of the cylinder of FIG. 9 taken along line EE;

FIG. 12 is a bottom view of the cylinder of FIG. 7;

FIG. 13 is a perspective view of the cylinder of FIG. 7;

FIG. 14 is a front view of a piston of the engine of FIG. 1;

FIG. 15 is a cross-sectional view of the piston of FIG. 14 taken along line M;

FIG. 16 is a side view of the piston of FIG. 14;

FIG. 17 is a front view of a cylinder according to another embodiment of the present invention;

FIG. 18 is a left-side view of the cylinder of FIG. 17;

FIG. 19 is a perspective view of the cylinder of FIG. 17;

FIG. 20 is a cross-sectional view of the cylinder of FIG. 18 taken along line AA;

FIG. 21 is a cross-sectional view of the cylinder of FIG. 18 taken along line BB;

FIG. 22 is a cross-sectional view of the cylinder of FIG. 18 taken along line CC;

FIG. 23 is a top view of a cover according to one embodiment of the invention;

FIG. 24 is a cross-sectional view of the cover of FIG. 23 taken along line EE;

FIG. 25 is a side view of the cover of FIG. 23;

FIG. 26 is a bottom view of the cover of FIG. 23;

FIG. 27 is a perspective view of the cover of FIG. 23;

FIG. 28 is a bottom view of a side cover according to one embodiment of the present invention;

FIG. 29 is a side view of the cover of FIG. 28;

FIG. 30 is a perspective view of the cover of FIG. 28;

FIG. 31 is a perspective view of a two-cycle engine according to one embodiment of the present invention;

FIG. 32 is a cross-sectional view of the engine of FIG. 31 showing the piston at top dead center position;

FIG. 33 is a perspective view of the engine of FIG. 32;

FIG. 34 is a cross-sectional view of the engine of FIG. 31 showing the crankshaft at about 120 degrees (ATDC) during the opening of the scavenging ports;

FIG. 35 is a cross-sectional view of the engine of FIG. 31 showing the crankshaft at bottom dead center position;

FIG. 36 is a cross-sectional view of the engine of FIG. 31 showing the crankshaft at about 120 degrees before top dead center, closing the scavenging ports;

FIG. 37 is a cross-sectional view of the engine of FIG. 31 showing the crankshaft at about 60 degrees before top dead center about to open the intake port;

FIG. 38 is a perspective view of a cross-section of an engine according to one embodiment of the present invention;

FIG. 39 is a perspective view of a piston of an engine according to one embodiment of the present invention;

FIG. 40 is a perspective view of portion of a cross section of the cylinder of an engine according to one embodiment of the present invention showing the air deflecting means to direct the scavenging flow into the appropriate direction;

FIG. 41 is another cross section of the scavenging windows showing the structures that provide the scavenging flow direction;

FIG. 42 is a perspective view of portion of a cylinder of an engine according to one embodiment of the present invention;

FIG. 43 is a cross section showing the scavenging passage an engine according to one embodiment of the present invention;

FIG. 44 is a perspective view of portion of a cylinder of an engine according to one embodiment of the present invention showing a lateral cover;

FIG. 45 is a perspective cross-sectional view of portion of engine according to one embodiment of the present invention;

FIG. 46 is a perspective cross-sectional view of portion of engine according to one embodiment of the present invention showing the passage communicating the blind port with the secondary scavenging conduit;

FIG. 47 is a perspective view of a cross section of a portion of a cylinder of an engine according to one embodiment of the present invention showing the transfer windows configuration;

FIG. 48 is a perspective view of an engine according to an alternate embodiment of the present invention, with certain conventional features omitted for increased clarity;

FIG. 49 is a front-facing perspective view of the block of the engine according to the alternate embodiment shown in FIG. 48;

FIG. 50 is a rear-facing perspective view of the block of the engine according to the alternate embodiment shown in FIG. 48;

FIG. 51 is a side view of the block of the engine according to the alternate embodiment shown in FIG. 48;

FIG. 52 is a side view opposite of the view shown in FIG. 51;

FIG. 53 is a cross-sectional side view of the block of the engine according to the alternate embodiment shown in FIG. 48;

FIG. 54 is a perspective view of a piston for use with the alternate embodiment shown in FIG. 48;

FIG. 55 is a cross-sectional side view of the piston shown according to FIG. 54;

FIG. 56 is a perspective view of a transfer passage cover for use with the engine shown according to FIG. 48;

FIG. 57 is a side view of the inside of the transfer passage shown according to FIG. 56;

FIG. 58 is a cross-sectional view of the engine shown according to FIG. 48 in the top dead center position;

FIG. 59 is a cross-sectional view of the engine shown according to FIG. 48 in a 124 degrees after top dead center position;

FIG. 60 is a cross-sectional view of the engine shown according to FIG. 48 in a 70 degrees after top dead center position;

FIG. 61 is another cross-sectional view of the engine shown according to FIG. 48 in a 70 degrees after top dead center position;

FIG. 62 is a cross-sectional view of the engine shown according to FIG. 48 in as the piston progresses towards the bottom dead center position;

FIG. 63 is a cross-sectional view of the engine shown according to FIG. 48 in the bottom dead center position;

FIG. 64 is an enlarged view of the view shown according to FIG. 63;

FIG. 65 is a cross-sectional bottom view of the block of the engine shown according to FIG. 48;

FIG. 66 is a cross-sectional view of the piston traveling towards the top dead center position according to the engine shown in FIG. 48;

FIG. 67 is a cross-sectional view of the engine shown in FIG. 48, wherein the piston is at 70 degrees before top dead center;

FIG. 68 is another cross-sectional view of the view shown according to FIG. 67;

FIG. 69 is a perspective view of a piston according to a further embodiment of the invention;

FIG. 70 is a side view of the piston shown in FIG. 69;

FIG. 71 is a top view of the piston shown in FIG. 69;

FIG. 72 is a side view of the piston shown in FIG. 69; and

FIG. 73 is a perspective view of a hand tool, particularly a chain saw, for use with the engine shown throughout the Figures.

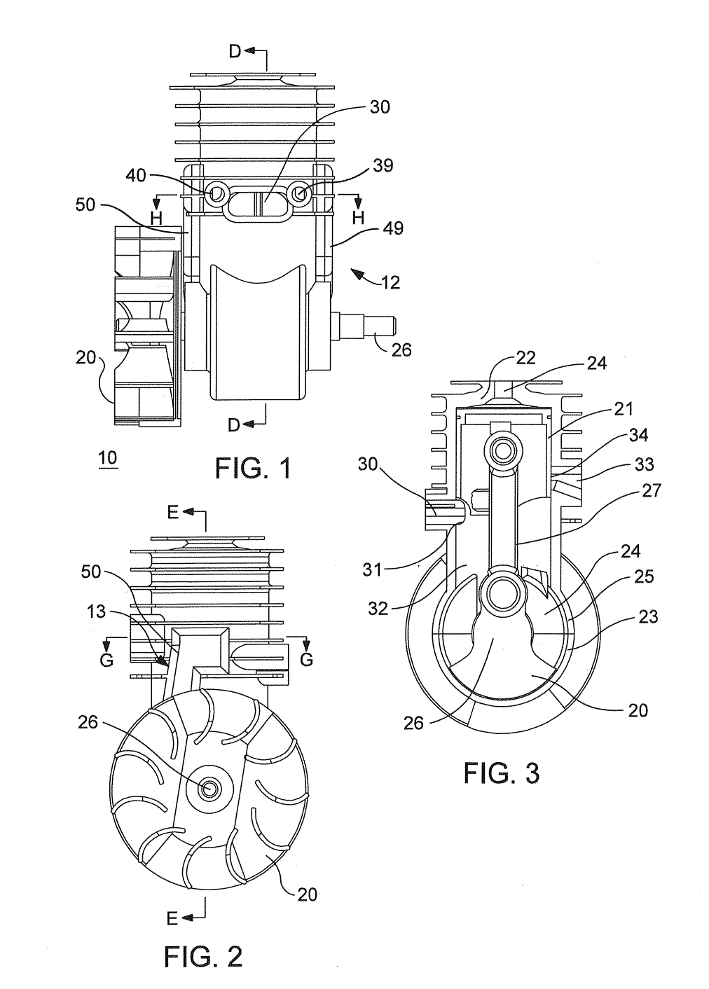

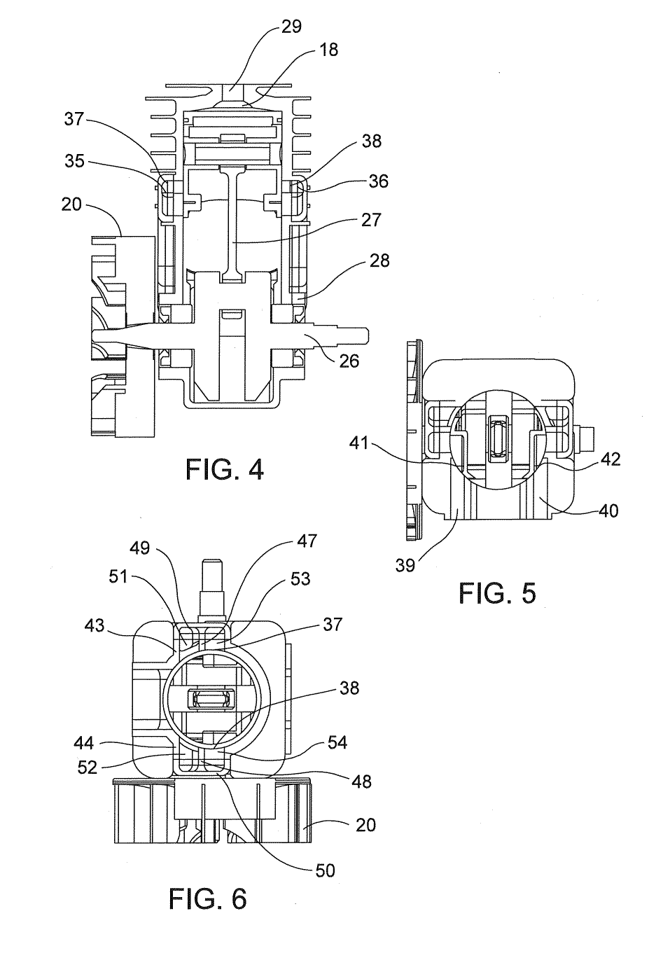

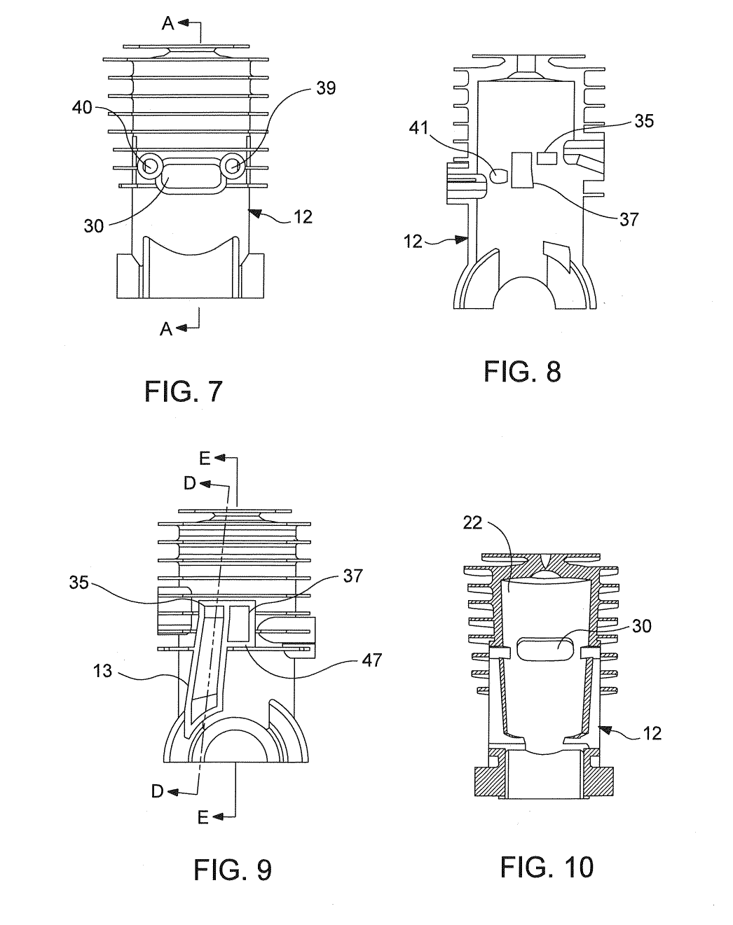

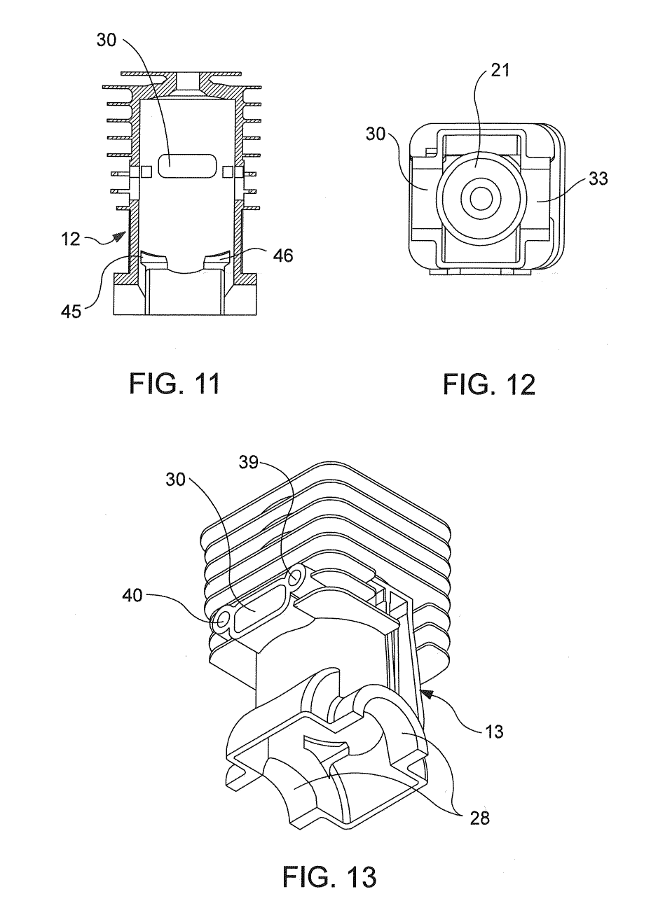

### DETAILED DESCRIPTION OF THE INVENTION

The present invention provides an engine that includes the basic elements found in traditional two-stroke engine as seen in the attached figures. According to a first embodiment, and specifically referring now to the engine assembly views as represented throughout the Figures and generally designated 10. A piston 21 is configured to move in a reciprocating motion within a cylinder 22, the cylinder 22 having a crankcase 25 and main bearing supports 28. Covering the bottom opening of the cylinder 22 is a crankcase cap 23. The crankcase cap 23 forms an internal chamber or crankcase 24 when joined with extended body 25 at the opened face of the cylinder 22. The piston 21 is attached to the crankshaft 26 by a connecting rod 27. Attached at one end of the crankshaft is the flywheel 20 having cooling fins and a set of magnets conventional within the art.

The crankcase 25 includes the crankshaft main bearing supports 28 that are shared with the crankcase cap as shown. The cylinder 22 defines a combustion chamber 18. A spark plug opening 29 is formed through the upper wall of the cylinder 22 and fluidly connects combustion chamber 18 with an outer surface of the cylinder 22. The cylinder wall of the cylinder 22 defines a surface 32 that defines a bore. An intake port passage 30, an intake port window 31 into the cylinder wall 32, the exhaust passage 33 and the exhaust port window 34 open into the bore. Air windows 41 and scavenging port windows 35, 37 also open into the bore. Also included in the cylinder structure are a left primary port window 35 and a right primary port window 36 and a left secondary port window 37 and a right secondary port window 38. Parallel to the intake port passage 30 are the air inlet passages 39 and 40 (left and right). The scavenging port passages are defined by channels formed in the external surface of the cylinder and a lateral cover. Corresponding left and right air intake windows 41 and 42 are located into the cylinder wall. On the side walls of the cylinder are located the portions of the primary 51, 52 and secondary transfer passages 53, 54, delimited by raised walls 43 and 44 on the primary ports sections and 47 and 48 for the secondary port section.

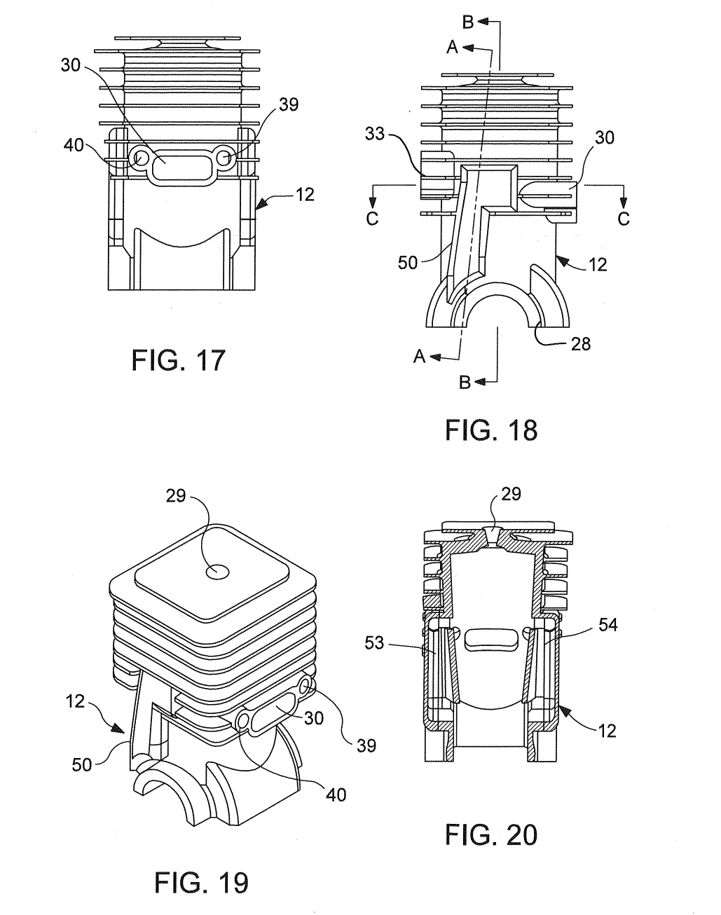

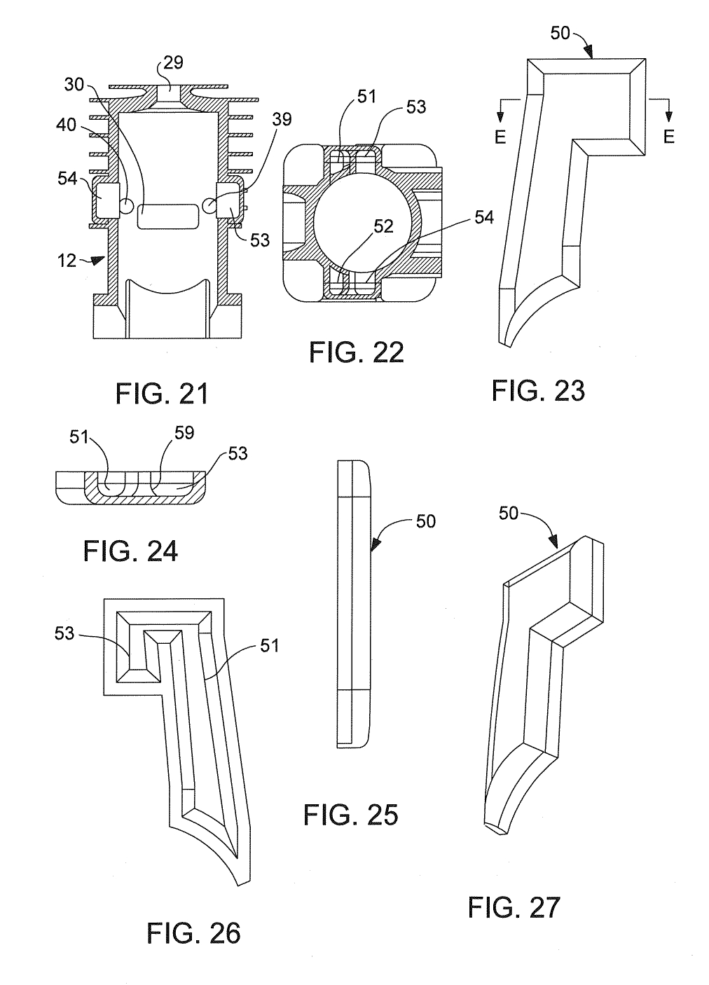

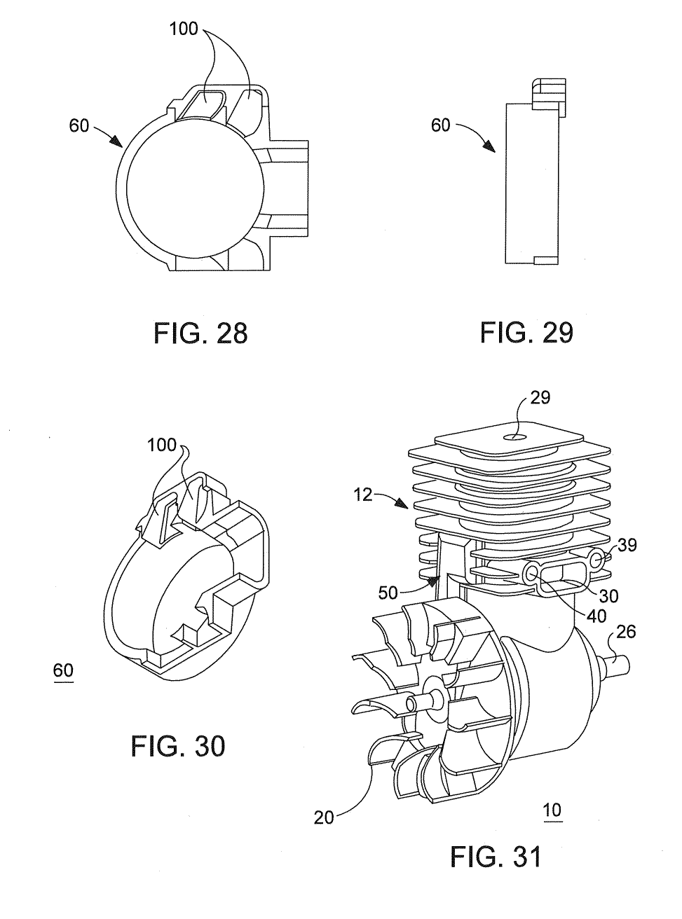

The cylinder transfer passage walls in combination with the matching transfer passage side covers 49 and 50, form the primary transfer passages 51 and 52 and secondary transfer passages 53 and 54. Sandwiched in between the transfer passages covers 49, 50 and the transfer passages walls, sealing means (not numbered) are located. These passages are shown in FIGS. 17-22.

Referring now to FIG. 6, transfer passage covers (right 49 and left 50), have identical walls cooperating with the cylinder transfer passage walls. In between these walls are located corresponding portions of the primary and secondary transfer passages. The cross-sectional area of each passage is at least equal the area of the corresponding port window. The effective cross-sectional area is important since it affects the crankcase compression ratio and the amount of air to store. The covers 49, 50 can be modified in any shape to provide the optimum scavenging loop for directional cover configuration. At the top portion of the covers 49, 50 is the area that is in cooperation with the primary transfer passage windows 35 and second secondary windows 36 and that will provide the nozzle structure 100 that will provide the directional effect for the gases ejected into the cylinder chamber. Also at top of the transfer passages covers 49, 50, the air window can be observed, i.e., an opening, communicating with the primary transfer passage 51 and the secondary transfer passage 53. This air window allows fluidic communication between the crankcase and air inlet hole.

Once assembled together, cylinder 22 and transfer passage covers 49 and 50, will form the cylinder assembly unit containing all the elements aforementioned. The external surface of the cylinder walls will contain cooling fins 200 distributed along the required areas.

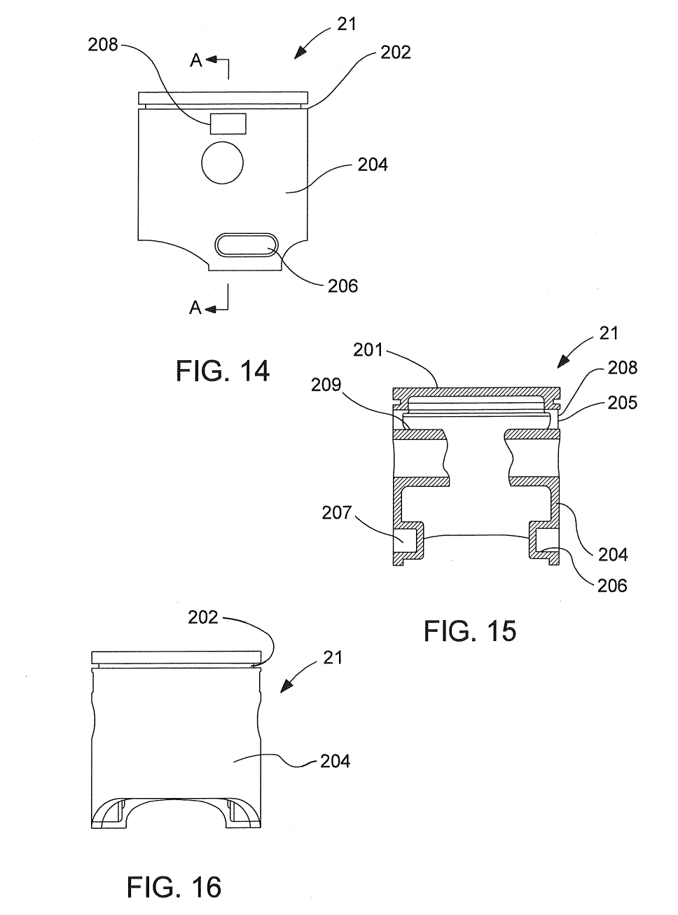

The piston 21 is shown in FIGS. 14 through 16 and 39. It contains the basic elements as in a typical two-cycle engine piston such as the piston crown 201, the piston ring groove 202 for locating the piston ring (not shown). The piston skirt 204, the piston wristpin supports 205. Located at the bottom of the piston skirt in both sides are the piston left and right air transfer passages 206 and 207. Piston openings 208 and 209 are positioned above a passage through the piston that is configured to receive a wristpin support.

All the other elements on this engine are very similar to the typical components. One exception is the induction system, which will have a carburetor for air/fuel mixture control and an air control throttle body for pure air induction control, or a carburetor with a combination of both.

The present invention can be better understood in light of a description of the operation as follows:

Generally, the cylinder has two sets, or pairs, of transfer or scavenging ports. The first set (secondary ports) is configured as a blind port and a second set (primary ports). Both set of ports are opened to the crankcase only when the piston opens the scavenging port windows, typically 20 degrees after the exhaust port opens. During this period, the windows 208, 209 through the wall of the piston communicates with the lower section of the blind port with the crankcase. In this manner, fluid communication between the cylinder chamber and the crankcase is established. The second set (primary ports are in constant communication with the crankcase.

As indicated above, the second set of scavenging ports includes conduits extending from the cylinder chamber into the crankcase under the lowest portion of the cylinder bore. These conduits are in constant communication with the crankcase. The communication with the cylinder chamber is provided when the piston is near the BDCP (Bottom Dead Center Position) (around 20 degrees after opening the exhaust port), opening the transfer or scavenging window.

These two set of scavenging ports work together in the following way: when the piston is in its ascending travel towards the TDCP (Top Dead Center Position), the volume on the crankcase is increased, thus creating a vacuum. This vacuum provides for the admission of the fuel/air mixture into the crankcase through the intake port and for the induction of air through the air ports. The intake port is opened to the crankcase by the piston skirt at approximately 80 degrees BTDC (Before Top Dead Center). Also during the ascending travel of the piston towards the TDC, the vacuum is transmitted inside the second pair (primary ports) of scavenging ports conduits. At the top of these conduits there is a communication passage to establish the fluid communication between these conduits and the blind port (secondary ports), which at this time is an enclosed space since is fully covered by the piston skirt. At this point of the process, the vacuum is also transmitted into the blind port. When the piston 21 is near the TDCP, the lower portion of the piston 21 has a cavity 206 that overlaps between the edge of the blind port and the air port into the cylinder wall. When this overlap occurs, the vacuum from the crankcase is transmitted to an air passage. When this occurs, air from the induction system, which may be a special dual bore carburetor or may be other induction means, is drawn through the air passage, and then to the blind port, and through the secondary primary scavenging port into the crankcase.

This process occurs using either system of communication between the two ports, the top cover passage or the channel into the piston skirt.

The system could be balanced in such a way that the air stream could fill the primary and secondary transfer conduits, with little volume entering into the crankcase, since this will have an adverse effect in the Air/fuel ratio of the mixture inside the crankcase.

When the piston starts descending towards the BDCP (Bottom Dead Center Position), the mixture into the crankcase is pressurized, as soon as the transfer windows are opened, the air contained into the primary transfer conduits and the blind conduits is ejected into the cylinder chamber. This volume of air called “the air head” is followed by the stream of air/fuel mixture. When the combustion gases are expelled or scavenged out of the cylinder chamber through the exhaust port, this air head prevents a significant amount of air/fuel mixture from escaping.

The primary ports create a dominant stream of air pointing towards the rear and upwards into the cylinder. Milliseconds later the secondary ports ejects a smaller fraction of air followed by air/fuel mixture, across the top of the piston and upwards.

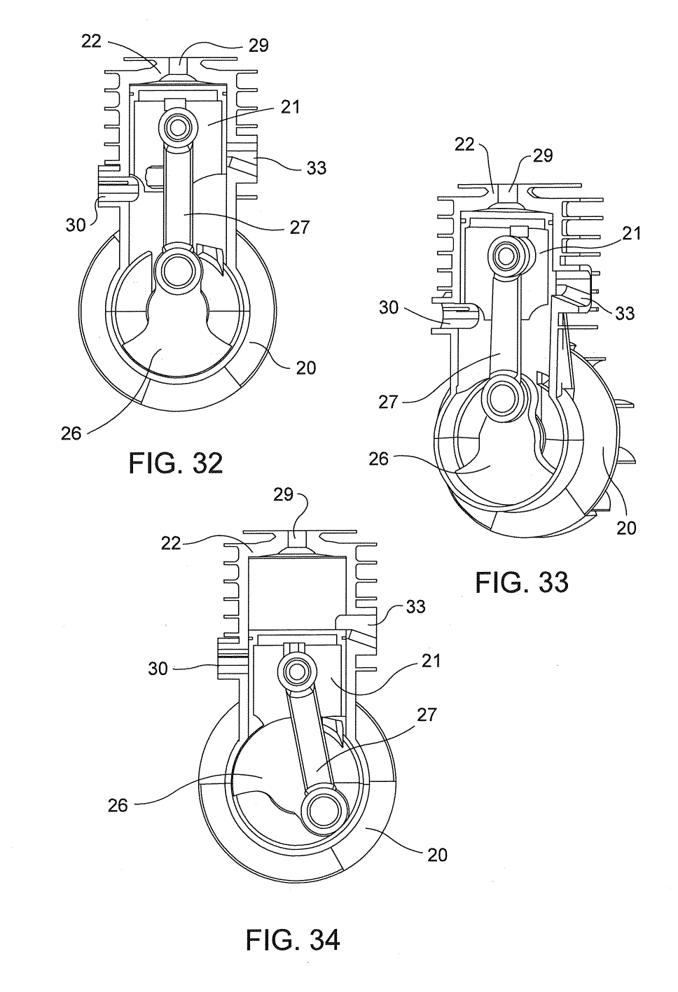

Referring now to FIG. 32, the TDCP picture shows the engine with the piston at the TDCP. At this stage the piston is about to be displaced downwards by the force of the combustion gases. The lower left section of the skirt has fully opened the intake port where the fuel/air mixture is being admitted into the crankcase chamber. Also the right portion of the skirt is covering the exhaust port. The air passages formed around the skirt of the piston are also covering the secondary transfer ports. The negative pressure existing into the crankcase is creating suction on the primary port crankcase window. This suction is transmitted through the transfer passage to the upper section of the transfer passage cover where the window communicating the secondary port and the primary port is located. By means of this communication, suction is then transmitted into the secondary transfer ports.

The secondary transfer ports are aligned in the lower section with a portion of the piston transfer passages. These transfer passages are also aligned with the air passages windows into the cylinder wall. By means of the fluidic communication, the suction transmitted into the secondary transfer ports is also transmitted into the air passages drawing air into the primary transfer passage.

FIG. 34 shows the piston 21 in the 125 ATDC position. As the combustion gases propel the piston towards the BDCP, the bottom edge of the skirt closes the intake port and starts compressing the mixture admitted during the last cycle. At the same time, the piston has uncovered a portion of the exhaust port, allowing the combustion gases to rush out of the cylinder chamber. The transfer port windows are about to be opened. The fuel mixture admitted into the crankcase chamber is compressed. The compressed air/fuel mixture is also compressing the column of air admitted into the primary transfer port through the crankcase opening of this port. The upper port window is closed at this time by the piston external wall.

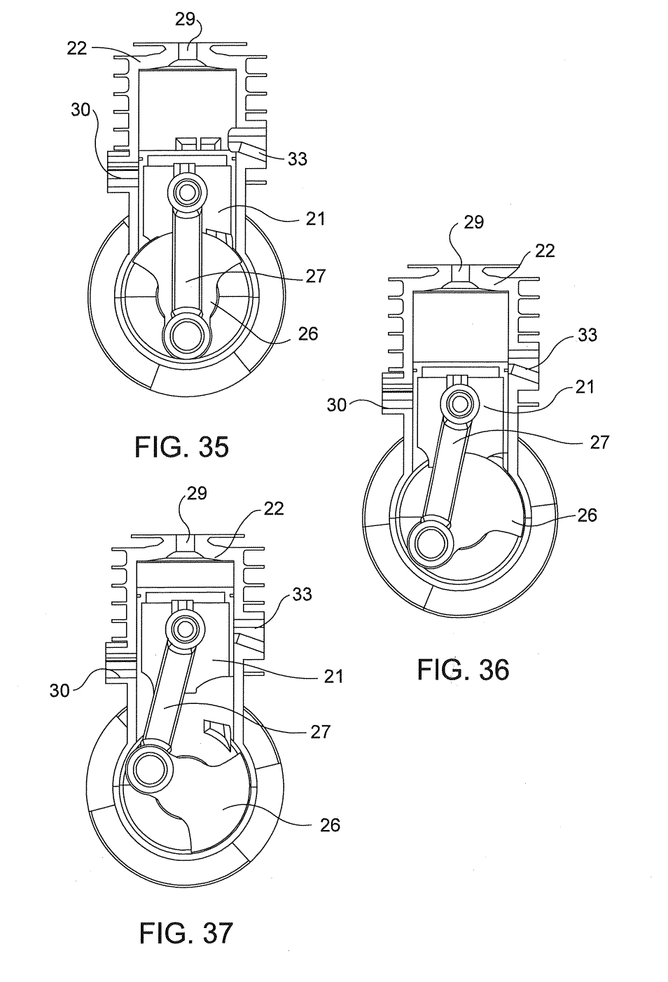

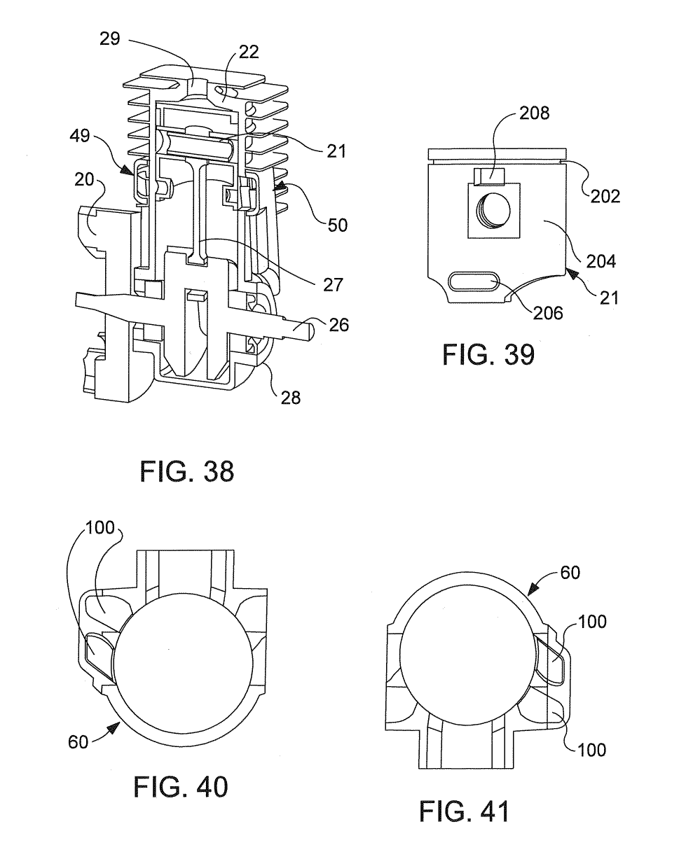

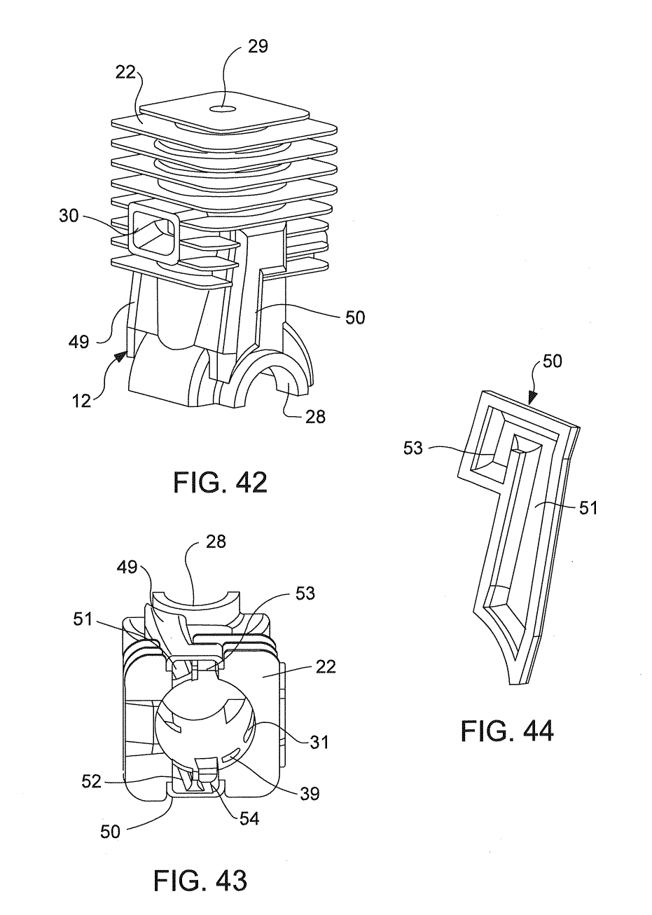

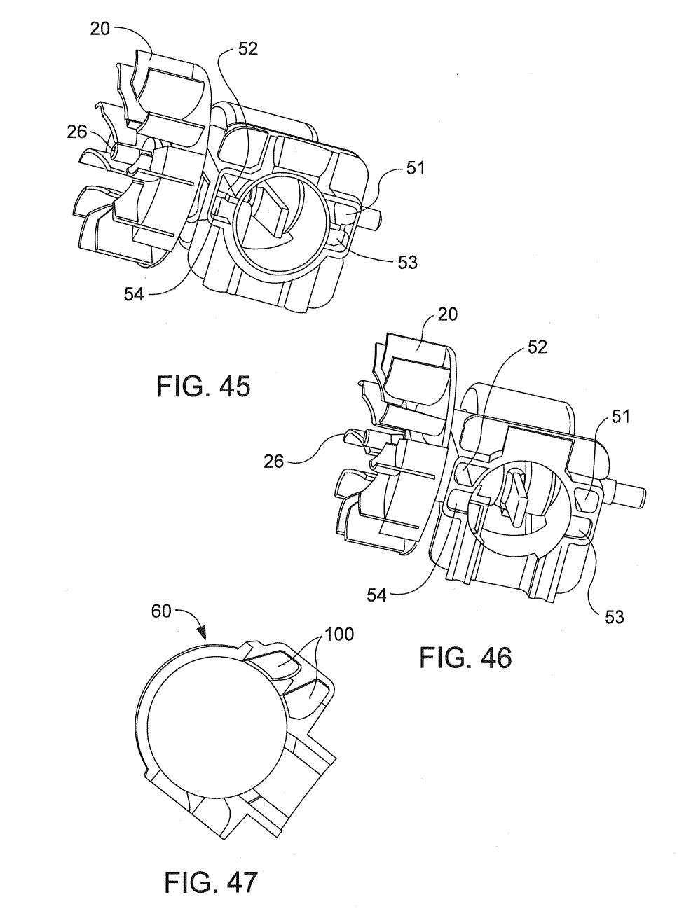

FIG. 35 shows the piston 21 in the BDC position. This stage illustrates what is about to happen inside the engine and the gas dynamics that will take place after the transfer ports are opened while the piston 21 reaches the BDC position. Initially the exhaust port is partially opened, and the transfer ports are closed. Typically this position is around 125 degrees after TDC. If the engine is rotating at 8000 RPM, it only takes approximately 0.001″ seconds to fully open the transfer ports and remain opened for about 0.002″ seconds. During this period of time, the already pressurized air contained into the transfer passages is ejected into the cylinder chamber. The air/fuel mixture held around the piston opening is finally discharged into the secondary transfer port, and released into the secondary transfer port window after the air from the primary port window has already circulated. The portion of air remaining into this port allows for this delay. This method of delaying the air/fuel discharge is the basic essence of the invention, which is achieved without adding complexity to the engine and avoiding the complexity of the blow-down gases dynamics. Theoretically, the volume of air ejected form the primary port circulates around the cylinder chamber and nearby the exhaust port. The following stream of air/fuel mixture follows the same path displacing the “air head” towards the exhaust port. When the exhaust port finally closes, most of the bypassed gases are mainly pure air. This minimizes the air/fuel mixture lost into the exhaust port, therefore reducing Hydrocarbon emissions.

Referring now to FIG. 36, the 125 BTDC picture shows the piston 21 just after closing the exhaust port, creating a vacuum into the crankcase. On top of the piston the air/fuel mixture starts being compressed.

Referring now to FIG. 37, the 60 degrees BTDC position shows the piston 21 at the instant of opening the intake ports. Air fuel mixture from the carburetor starts being drawn into the crankcase. Compression of the air/fuel mixture increases.

Referring now to FIG. 32, the piston is shown in the TDCP. Vacuum in the crankcase still exists due to the restriction into the intake tract created by the carburetor venturi and throttle valve. At this point the channel in the piston communicates the air passage with the primary transfer port filling it with air and the cycle repeats. Simultaneously, the compressed air fuel mixture is ignited and the piston is forced towards the BDC position.

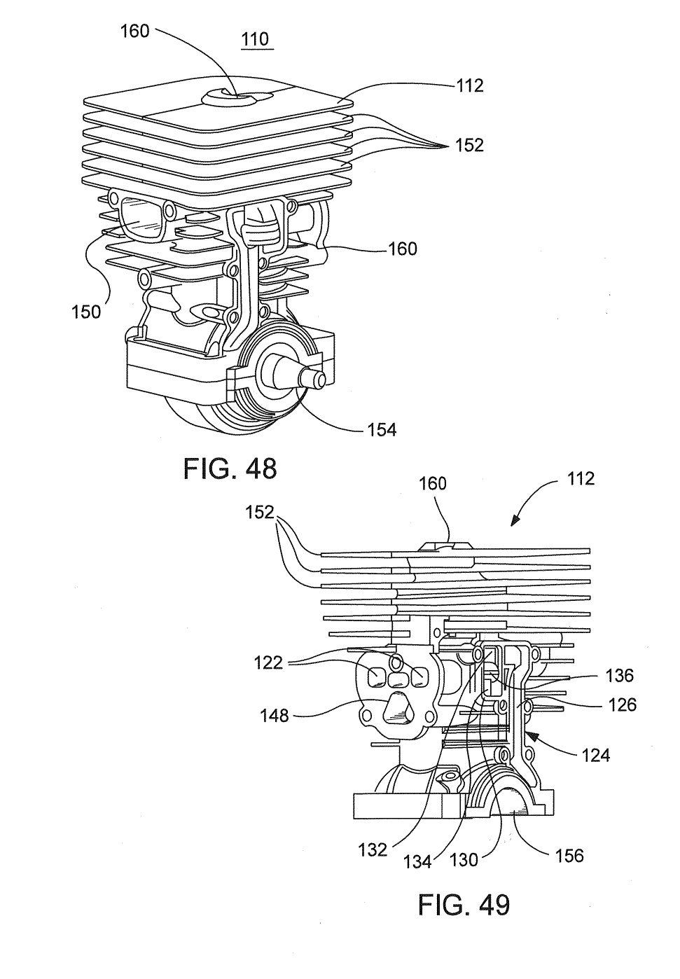

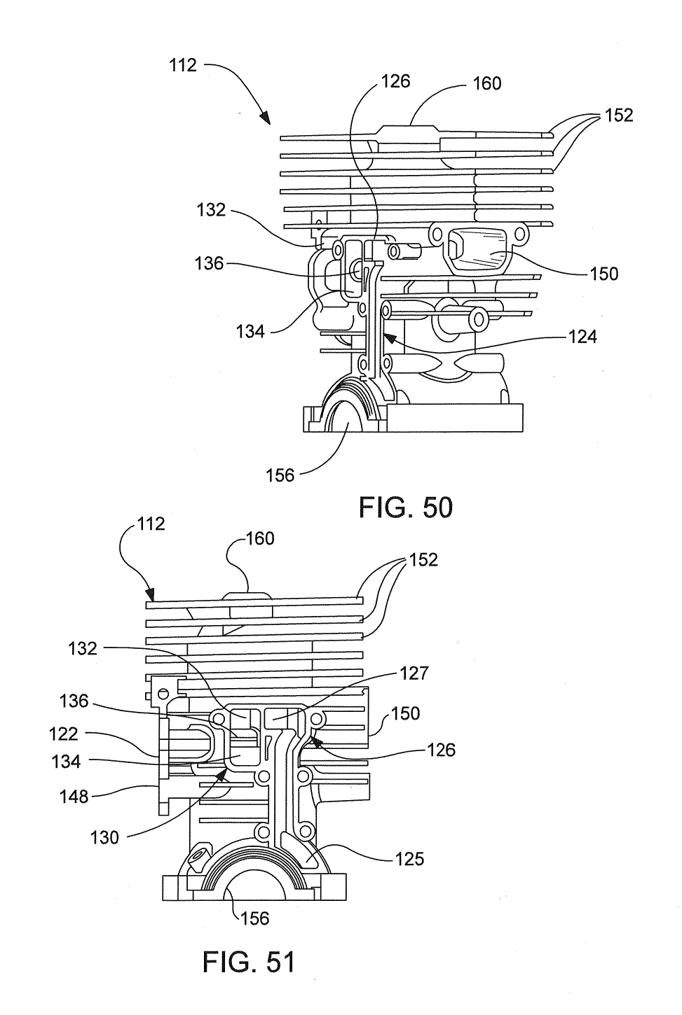

According to another preferred embodiment, a differently configured two-stroke internal combustion engine 110 is shown in FIGS. 48 through 67. In particular detail as shown in FIG. 48, the engine 110 includes a block 112, an exhaust port 150 for exhausting spent fuels to an environment, a spark plug opening 159 preferably having a threaded insert therein for receiving a spark plug, cooling fins 152 for radiating heat, and a crankshaft 154 provided for rotating a piston connected with a connecting rod and for providing power output to an accessory such as a centrifugal clutch. A transfer passage cover 160 is also provided and will be discussed with reference to subsequent Figures.

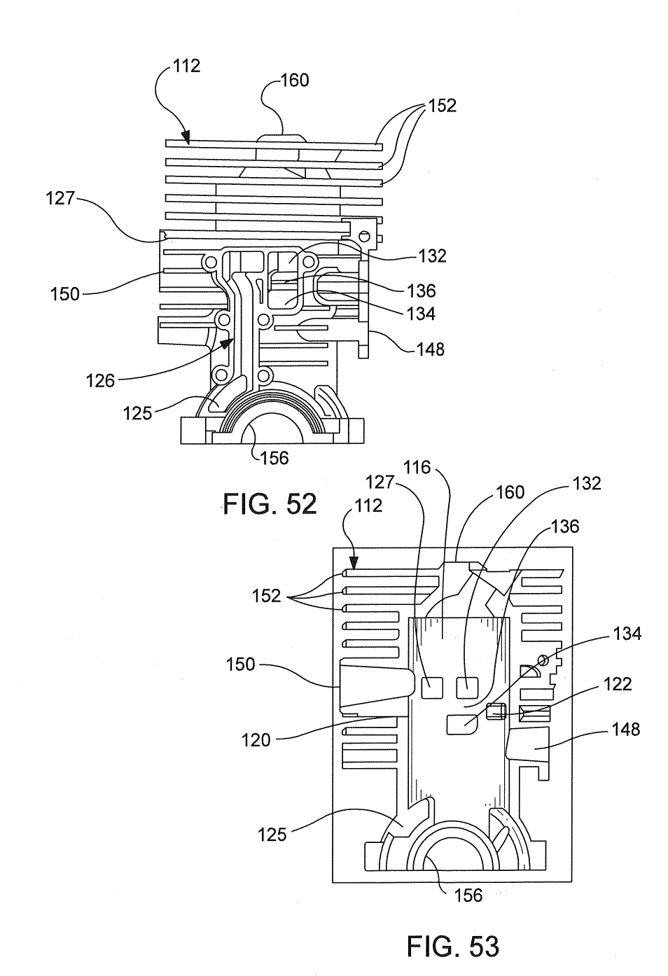

As shown in FIGS. 49 through 52, the block 112 includes an intake port 148 for providing an air/fuel mixture into the engine block 112. A plurality of air passages 122 are provided, and are preferably positioned in laterally spaced-apart configurations. A scavenging transfer passage 124 is provided and is covered by the transfer passage cover 160 shown in FIG. 48. The scavenging transfer passage 124 communicates between the crankcase 114 and cylinder chamber 116 formed within the engine block 112. The transfer passage 124 has a primary transfer port 126 in communication with a secondary transfer port 130 that includes a first window 132 and a spaced-apart second window 134. The space defined between the first window 132 and the second window 134 defines a bridge 136, which is optionally provided. A crank bearing journal 156 is configured to rotatably receive the crankshaft 154. A lower transfer port window 125 is provided at the bottom of the primary transfer port 126 and, likewise, an upper transfer port window 127 is provided at the top of the primary transfer port 126. A cross-section of engine block 112 is provided in FIG. 52. FIG. 53 shows the relationship between the transfer port windows 125, 127 and secondary port windows 132, 134 formed in the cylinder bore 120.

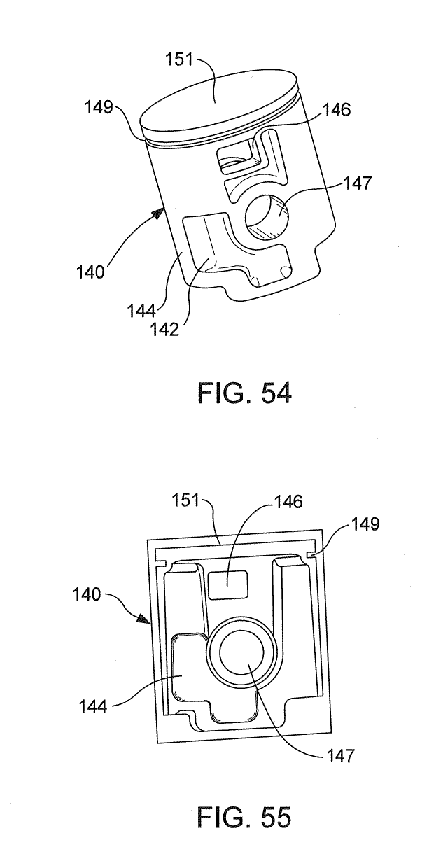

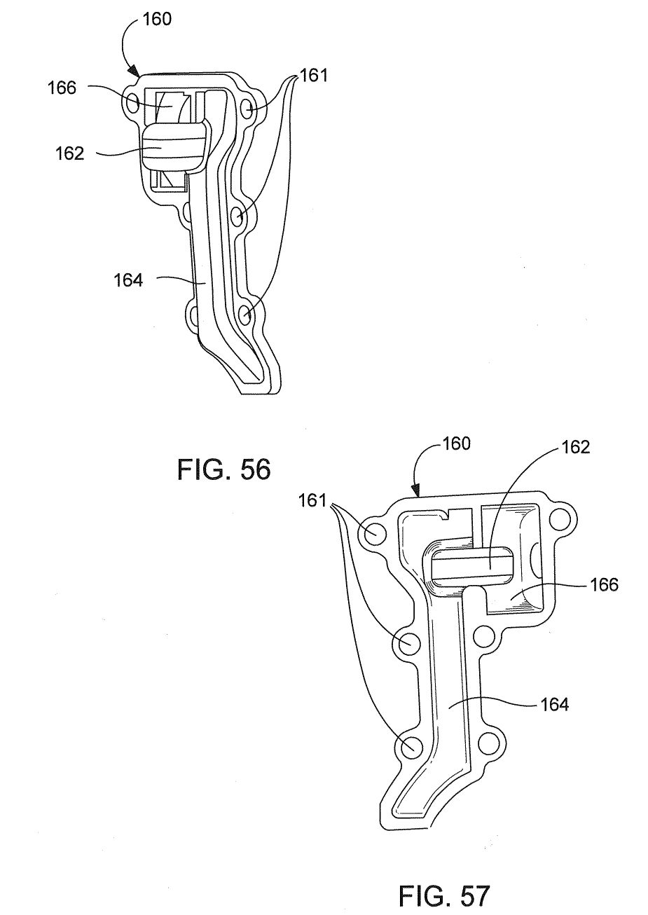

As shown in FIGS. 54 and 55, a piston 140 is provided and is adapted for reciprocating vertical movement within the cylinder bore 120. The piston 140 shares many characteristics of a conventional piston including a piston dome 151, a piston ring groove 149 for receiving a piston compression or scraper ring, a wrist pin opening 147 for receiving a wristpin and connecting the piston 140 to the connecting rod. In addition, the piston 140 includes a channel 142 for providing a transfer passageway for air received within air passages 122. As shown in FIG. 54, channel 142 is oriented such that the large cross-section portion, termed an inset, (the left most portion in FIG. 54) faces and communicates with air passages 122. This inset has a larger longitudinal length to allow a greater period of air intake as the piston 140 travels vertically within the cylinder bore 120. The portion of the channel 142 that is located furthest to the right at the distal end as shown in FIG. 54 is for communicating with either the first window 132 or second window 134 of the secondary port 130. As shown, the area of channel 142 generally defined to the left of the curved portion medially located in the channel generally corresponds to the area of either of the first window 132 or second window 134 of the secondary port 130. A piston opening 146 is also defined in the piston 140, the piston opening 146 also having an area that generally corresponds to the area of either of the first window 132 or the second window 134 of the secondary port 130. Piston opening 146 provides selective communication between the crankcase 114 and either window 132, 134 of the secondary port 130, thereby allowing scavenged fuel to pass therethrough when communication exists between either window 132, 134 and the piston opening 146. Piston 140 is preferably manufactured with a three-piece core to reduce weight.

FIGS. 56 and 57 detail transfer passage cover 160. The transfer passage cover 160 defines a plurality of apertures 161 for receiving a fastener for fastening the transfer passage cover 160 to a corresponding aperture on the block 112 and securing the transfer passage cover 160 thereon. The transfer passage cover 160 defines a main channel 164 and a loop 162 for providing communication between the primary transfer port 126 and the secondary transfer port 130. Loop 166 provides a communication pathway between the first window 132 and the second window 134 of the secondary transfer port 130.

Cover 160 is manufactured with a simple two-piece die. In preferred embodiments, the engine 110 defines one transfer passage on each opposing side facing the rotational axis of the crankshaft 154.

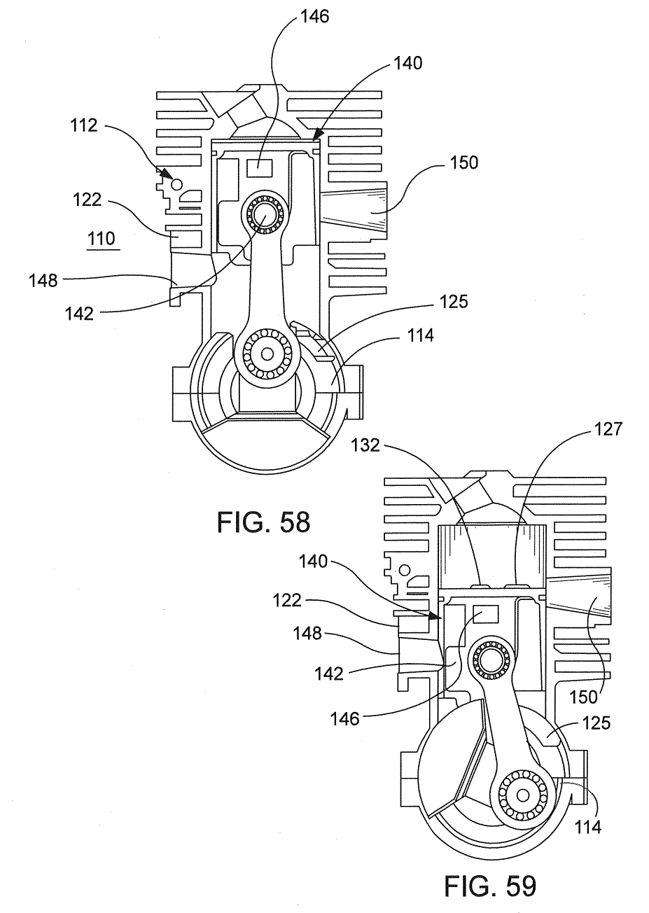

Operation of the two-stroke internal combustion engine 110 will now be described. As shown in FIG. 58, the engine 110 is shown in the Top Dead Center Position (TDCP). At this point in the process, gases are being compressed on top of the piston 140 while an air-fuel mixture is being admitted into the crankcase 114. Air is also being admitted through the air passages 122, into the second window 134 and then into the first window 132 of the secondary transfer port 130, and then into the primary transfer port 126.

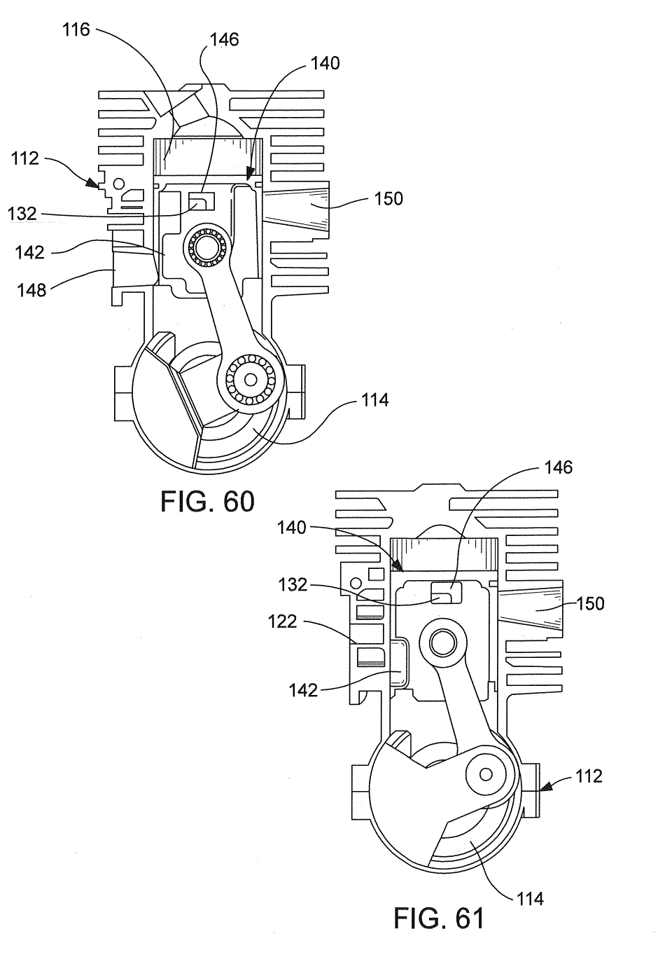

As shown in FIG. 59, the piston 160 has closed the intake port 148 at 70 degrees ATDC (after top dead center). At this point is when pressure starts building up in the crankcase 114. Even with communication between the piston opening 146 and the secondary transfer port 130, the dynamic of gases into the crankcase of the engine 110 is such that pressure into the crankcase 114 has not increased to the point that any substantial backflow will occur through the transfer passage 124. In preferred embodiments, the channel 142 is still in communication with the air passage 122 but communication is about to close as the piston 140 moves downward. This is illustrated clearly in FIG. 60.

As the piston 140 descends within cylinder bore 120 at 100 degrees ATDC. At this point, the piston dome 151 begins to open the exhaust port. The first window 132 of the secondary port 130 is in communication with the crankcase 114 through the piston opening 146, however, no communication exists between the air passages 122 and the piston channel 142, and air trapped within transfer passage 124 should stay stagnant due to relatively equal pressure on between the crankcase 114 and the cylinder chamber 116.

As shown in FIG. 61, the piston 140 is positioned at 124 degrees ATDC. At this point, the piston 140 is positioned to open the transfer passage 124, in particular upper transfer passage window 127 and the first window 132 of the secondary port 130. At this point in the engine cycle, the primary transfer port 126 is one fourth of its height opened, however, the secondary port 130 is closed by the bridge 136 positioned in front of the piston opening 146. This produces the sufficient delay to allow the air found in the primary transfer port 126 and the secondary transfer port 130 to fill the cylinder chamber 116 with air before full scavenging with the crankcase 114 occurs and air-fuel mixture is introduced.

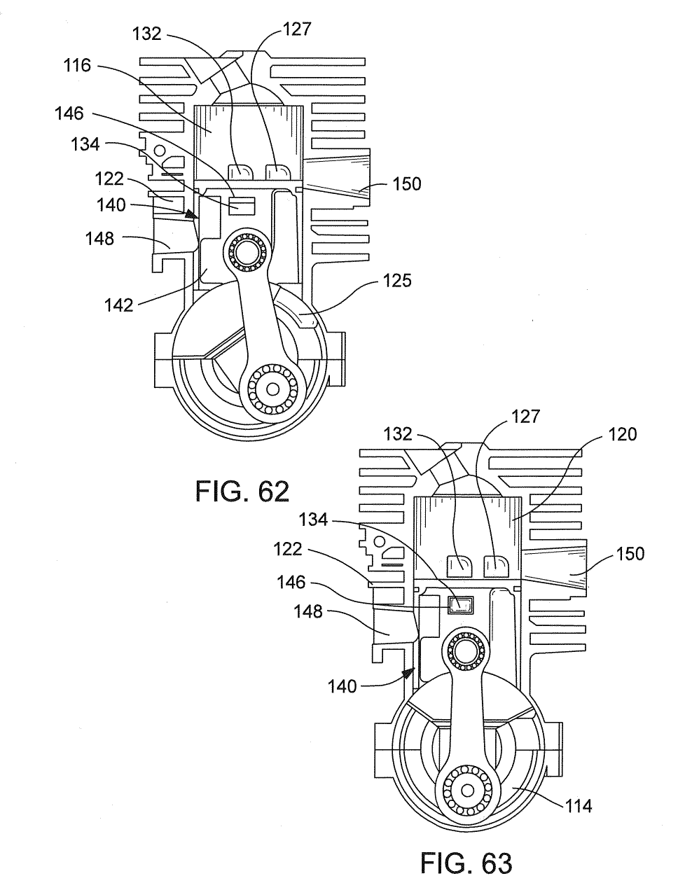

As shown in FIG. 62, as the piston 140 progresses towards the Bottom Dead Center Position (BDCP), both the primary transfer port 126 and the secondary transfer port 130 become fully opened to allow full communication with the crankcase 114, thereby forcing the flow of any remaining air-fuel mixture into the cylinder chamber 116.

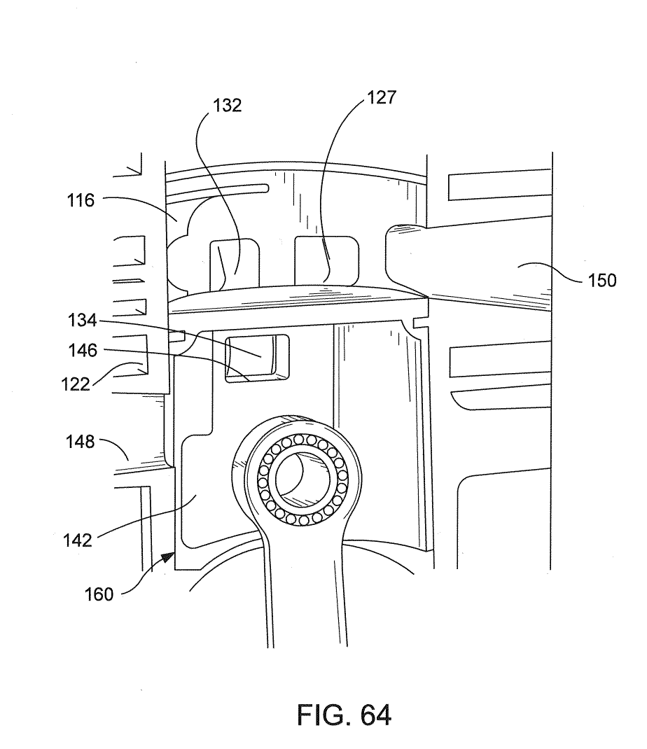

The piston 140 is shown in the BDCP in FIG. 63. The primary transfer port 126 and the secondary transfer port 130 are fully opened and exhaust gases are being evacuated from the cylinder chamber 116 through the exhaust port 150. The cylinder chamber is being filed with air-fuel mixture. An enlarged view is shown in FIG. 64 and shows with clarity the configuration of the first window 132 and the second window 134 of the secondary port 130, along with the upper transfer window 127 of the primary transfer port 126.

As the piston 140 continues to travel vertically towards the top dead center position, the scavenging period is preferably complete at approximately 124 degrees BTDC and has a period length of approximately 112 degrees.

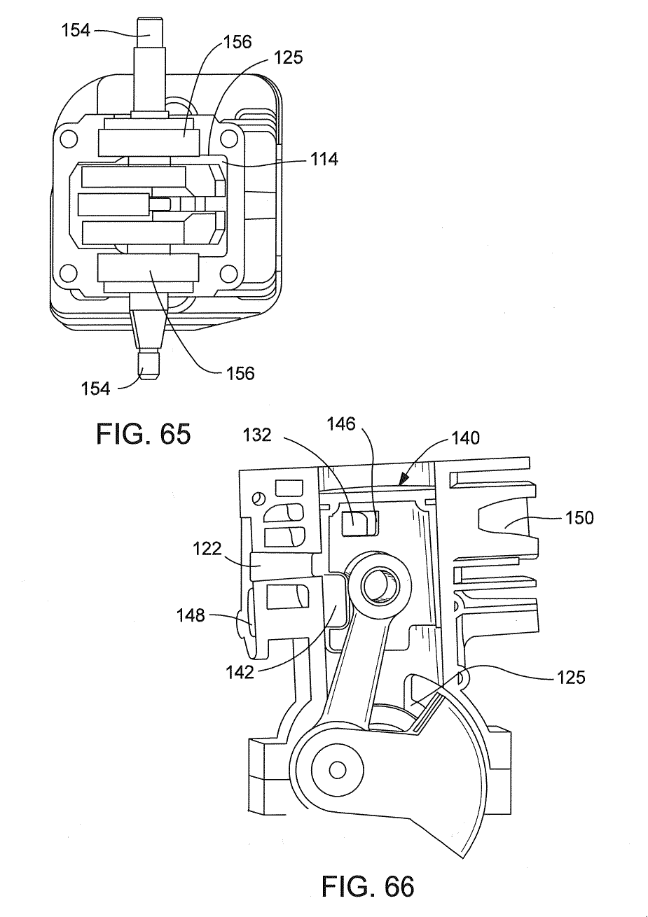

As shown in FIG. 65, a gap “G” is defined between the crankshaft counterweights 157 and the bottom transfer window 125 of the primary transfer port 126. This gap “G” represents an enlarged gap over the prior art so as to allow sufficient fluid flow through the primary transfer port 126 without significantly sacrificing crankcase pressure.

As shown in FIG. 66, the exhaust port 150 has been closed. Preferably, the exhaust period is between 90 and 120 degrees. After the exhaust port 150 has been closed, the compression cycle beings and negative pressure continues to build up within the crankcase. At the point shown in FIG. 66, the piston 150 inset will momentarily allow air to flow within from the air passages 122.

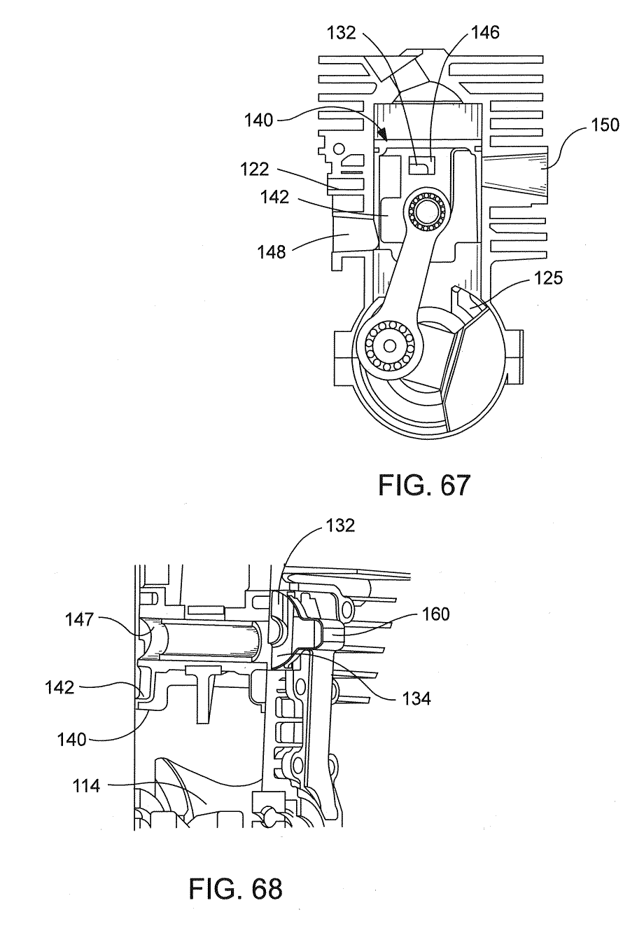

As shown in FIG. 67, the piston 140 is at 70 degrees BTDC. The intake port 148 begins to open and air-fuel mixture is drawn through a carburetor, and simultaneously, air is drawn through the secondary port passage 130 into the primary transfer port 126. At this point, as represented by the cross-sectional view of FIG. 68, the secondary port 130 is not opened to the piston channel 142 but communication will momentarily begin. Subsequently, the piston 150 reaches the TDCP and the cycle begins again.

One of the improved features of the design is that an air head is provided within secondary port 130 during operation of the engine 110. This is effective to delay the discharge of air/fuel mixture from the crankcase 114 through the secondary port 130 into the cylinder chamber 116.

To improve the aerodynamics of the air flow at the moment of scavenging, this passage can be replaced by a using window 247 around the skirt of the piston, communicating the upper window of the secondary scavenging port with the window of the primary port. This window will provide the fluid communication between the secondary and primary ports.

When a modified piston air passage is used instead of the side covers passage, an air passage around the piston skirt communicates the upper window or section of the blind port (secondary) with the window of the primary port. At the same time a lower passage 242 establishes the fluid communication between the lower window or portion of the blind port with the air port. This creates an air flow through the whole volume of the blind port.

Alternatively, instead of using this transfer loop 162, the piston could be fitted with an additional air passage for establishing the fluid communication between the upper window of the secondary port, with the window of the primary port. The communication between the two sets of ports will be open only when these air passages over the piston skirt is aligned with the corresponding windows in the vicinity of the Top Dead Center Position.

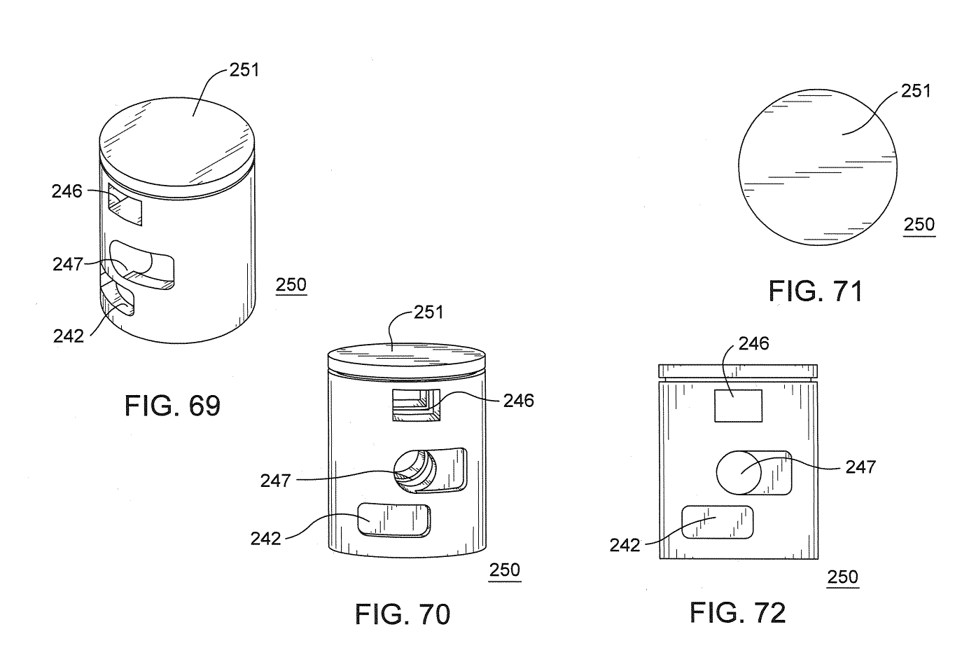

As an alternative to this upper window on the side cover, a modified piston can be utilized for the same purpose and will be discussed in regards to FIGS. 69 through 71. This piston 250 includes a piston dome 251, a piston wrist pin opening and upper passage combination 247, a lower passage 242, and an upper passage 246, similar to those found in reference to the previously described embodiments. The passage 247 is aligned to the secondary port upper window 132 and the primary port window thus establishing a fluid communication when the piston is in the vicinity of the TDC. Simultaneously, the lower window 242 is aligned with the air port 134 in the cylinder wall and the lower window of the secondary port 134.

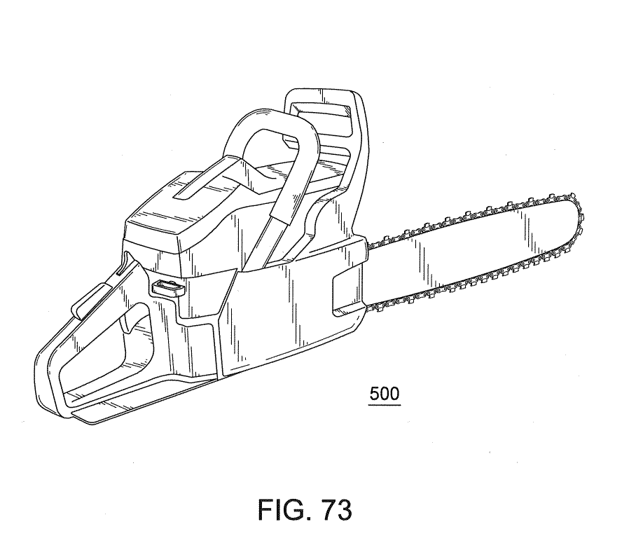

FIG. 73 represents a hand-held tool, such as a chainsaw as depicted, that can be used in combination with engines 10 or 110.

The foregoing has described a two-stroke engine having ports and openings configured in the piston and the cylinder for scavenging. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

I claim:

1. A two-stroke internal combustion engine, comprising:
a block defining a crankcase for enclosing a fuel mixture and a cylinder chamber formed at an end of a cylinder bore;
a crankshaft adapted for reciprocating movement and connected to the piston by a connecting rod, the crankshaft having crankshaft counterweights provided thereon.
an air passage in fluid communication with the cylinder bore;
a scavenging transfer passage communicating between the crankcase and the cylinder chamber and having a primary transfer port in communication with a secondary transfer port, the secondary transfer port having a first and a spaced-apart second window with a bridge spanning the space therebetween; and
a piston slideably positioned in the cylinder bore and having one or more channels formed in a periphery of the piston for selectively communicating the crankcase with the air supply channels and having a piston opening defined therein for providing selective communication between the crankcase and the transfer passage;
wherein air flows through the air passage, then through the piston channels, then into the second window of the secondary transfer port, then through the first window of the secondary transfer port, and then into the primary transfer port where the air remains relatively stagnant as the piston moves towards a top dead center position, the air from the primary transfer port then flows into the cylinder chamber and is followed by the fuel mixture flowing from the crankcase as the piston slides towards a bottom dead center position while the bridge blocks the piston opening from communicating with the secondary transfer passage during a portion of the cylinder cycle before the piston slides to the bottom dead center position and full communication exists between the crankcase, the piston opening, and the second window of the secondary transfer passage, thereby evacuating any remaining air within the secondary transfer passage into the cylinder chamber followed by the fuel mixture from the crankcase.

2. The engine according to claim 1, wherein the transfer passage is positioned on an exterior of the block and has a cover provided thereon for maintaining a sealed transfer passage.

3. The engine according to claim 1, wherein the air passage comprises two air interstices and further wherein, the piston comprises two channels, each channel formed in relative alignment with the a corresponding air interstice.

4. The engine according to claim 1, wherein the piston comprises two channels, wherein the first channel is provided for selective alignment between the air passage within the cylinder wall and the second channel is provided for alignment of the first window of the secondary port and the primary port.

5. The engine according to claim 1, wherein the primary transfer port is in communication with the secondary transfer port by an opening between the uppermost section of the primary port conduit and the secondary port passage

6. The engine according to claim 1, wherein the first and second spaced-apart windows have generally equal areas.

7. The engine according to claim 1, wherein the piston opening has a generally equal area with either of the first or second spaced-apart windows.

8. The engine according to claim 7, wherein the transfer passage communicates with the crankcase through a lower transfer passage window and further wherein a gap of sufficient size so as to allow sufficient fluid flow through the lower transfer passage window is provided between the lower transfer passage window and the crankshaft counterweights while maintaining the crankcase volume to a minimum size.

9. A two-stroke internal combustion engine, comprising:
a block defining a crankcase for enclosing a fuel mixture and a cylinder chamber formed at an end of a cylinder bore;
a crankshaft adapted for reciprocating movement and connected to the piston by a connecting rod, the crankshaft having crankshaft counterweights provided thereon.
an air passage in fluid communication with the cylinder bore;
a scavenging transfer passage communicating between the crankcase and the cylinder chamber and having a primary transfer port in communication with a secondary transfer port; and
a piston slideably positioned in the cylinder bore and having one or more channels formed in a periphery of the piston for selectively communicating the air ports with the secondary ports and the first port, and having a piston opening defined therein for providing selective communication between the crankcase and the transfer passage;
wherein air flows through the air passage, then through the piston channel, then into the secondary transfer port, then through the piston opening, and then into the primary transfer port where the air remains relatively stagnant as the piston moves towards a top dead center position, the air from the primary transfer port then flows into the cylinder chamber and is followed by the fuel mixture flowing from the crankcase as the piston slides towards a bottom dead center position and full communication exists between the crankcase, the piston opening, and the secondary transfer passage, thereby evacuating any remaining air within the secondary transfer passage into the cylinder chamber followed by the fuel mixture from the crankcase.

10. The engine according to claim 9, wherein the transfer passage is positioned on an exterior of the cylinder bore and has a cover provided thereon for maintaining a sealed transfer passage.

11. The engine according to claim 9, wherein the air passage comprises two air interstices and further wherein, the piston comprises two channels, each channel formed in relative alignment with the a corresponding air interstice.

12. The engine according to claim 9, wherein the air passage comprises two air interstices and further wherein, the piston comprises two sets of channels, one set of channels formed in relative alignment with the a corresponding air interstice, a second set of channels in relative alignment with the secondary port and the primary port.

13. The engine according to claim 9, wherein the piston opening has a generally equal width as either of the first or second spaced-apart windows.

14. The engine according to claim 9, wherein the transfer passage communicates with the crankcase through a lower transfer passage window and further wherein a gap of sufficient size so as to allow sufficient fluid flow through the lower transfer passage window is provided between the lower transfer passage window and the crankshaft counterweights.

15. A handheld tool comprising:
an engine for providing power to the tool, the engine, comprising:
a) a block defining a crankcase for enclosing a fuel mixture and a cylinder chamber formed at an end of a cylinder bore;
b) an air passage in fluid communication with the cylinder bore;
c) a scavenging transfer passage communicating between the crankcase and the cylinder chamber and having a primary transfer port in communication with a secondary transfer port; and
d) a piston slideably positioned in the cylinder bore and having a channel formed in a periphery of the piston and having a piston opening defined therein for providing selective communication between the crankcase and the transfer passage;
e) wherein air flows through the air passage, then through the piston channel, then into the secondary transfer port, and then into the primary transfer port where the air remains relatively stagnant as the piston moves towards a top dead center position, the air from the primary transfer port then flows into the cylinder chamber and is followed by the fuel mixture flowing from the crankcase as the piston slides towards a bottom dead center position and full communication exists between the crankcase, the piston opening, and the secondary transfer passage, thereby evacuating any remaining air within the secondary transfer passage into the cylinder chamber followed by the fuel mixture from the crankcase.

16. The engine according to claim 15, wherein an intake port is in communication with the crankcase for passing the fuel mixture thereto and further wherein the air passage is positioned between the intake port and a top of the block.

17. The engine according to claim 15, wherein the transfer passage is positioned on an exterior of the block and has a cover provided thereon for maintaining a sealed transfer passage.

18. The engine according to claim 15, wherein the secondary transfer port has a first and a spaced-apart second window with a bridge spanning the space therebetween, and wherein the bridge blocks the piston opening from communicating with the secondary transfer passage during a portion of the cylinder cycle before the piston slides to the bottom dead center position and full communication exists between the crankcase, the piston opening, and the second window of the secondary transfer passage.

19. The engine according to claim 18, wherein the piston opening has a generally equal area as either of the first or second spaced-apart windows.
